(19) United States
(12) Patent Application Publication
(10) Pub. No.: US 2008/0021944 A1
(43) Pub. Date: Jan. 24, 2008

(54) Method and apparatus for reducing jitter in output signals from a frequency synthesizer using a control word having a fractional bit

(75) Inventor: Liming Xiu, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/489,982

(22) Filed: Jul. 20, 2006

(51) Int. Cl. G06F 1/02

(52) U.S. Cl. 708/270

(57) ABSTRACT

A method for reducing jitter in an output signal from a frequency synthesizer using a control word having a fractional bit includes dividing the output signal by a predetermined divisor to present a modified output signal substantially free of jitter.

### BACKGROUND OF THE INVENTION

The present invention is directed to frequency synthesizers, and especially to frequency synthesizers treating a reference input signal to present a synthesized output signal having an output frequency and a delay with respect to the input reference signal that is related with at least one control word. The present invention is particularly useful with such a frequency synthesizer device that employs a control word having a fractional bit. When such a frequency synthesizer device employs a control word having a fractional bit there may be jitter in output signals from the synthesizer device.

There is a need for a method and apparatus for reducing jitter in an output signal from a frequency synthesizer using a control word having a fractional bit.

### SUMMARY OF THE INVENTION

A method for reducing jitter in an output signal from a frequency synthesizer using a control word having a fractional bit includes dividing the output signal by a predetermined divisor to present a modified output signal substantially free of jitter.

An apparatus for synthesizing a desired signal substantially free of jitter includes: (a) a frequency synthesizing device employing a control word having a fractional bit and presenting an output signal; and (b) a dividing unit coupled with the frequency synthesizing device. The dividing unit divides the output signal by a divisor to present the desired signal.

It is, therefore, an object of the present invention to provide a method and apparatus for reducing jitter in an output signal from a frequency synthesizer using a control word having a fractional bit.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic block diagram illustrating the apparatus of the present invention.

FIG. 2 is a timing diagram illustrating operation of the present invention.

FIG. 3 is a flow chart illustrating the method of the present invention.

### DETAILED DESCRIPTION OF THE PREFERRED EMBODIMENT

The term “locus” is intended herein to indicate a place, location, locality, locale, point, position, site, spot, volume, juncture, junction or other identifiable location-related zone in one or more dimensions. A locus in a physical apparatus may include, by way of example and not by way of limitation, a corner, intersection, curve, line, area, plane, volume or a portion of any of those features. A locus in an electrical apparatus may include, by way of example and not by way of limitation, a terminal, wire, circuit, circuit trace, circuit board, wiring board, pin, connector, component, collection of components, sub-component or other identifiable location-related area in one or more dimensions. A locus in a flow chart may include, by way of example and not by way of limitation, a juncture, step, site, function, query, response or other aspect, step, increment or an interstice between junctures, steps, sites, functions, queries, responses or other aspects of the flow or method represented by the chart.

One representative known circuit arrangement for effecting signal synthesis is known as a “Flying Adder” frequency synthesis architecture. The architecture is described in “An Architecture of High Performance Frequency and Phase Synthesis”, by Hugh Mair and Liming Xiu; IEEE Journal of Solid-State Circuits, Vol. 35, No. 6, June 2000. Mair and Xiu describe a Voltage Controlled Oscillator (VCO) presenting thirty-two phases as input signals to multiplexer devices.

As described by Mair and Xiu, in the flying adder frequency synthesis architecture a frequency synthesis section includes a frequency synthesizer multiplexer device that selects one of the thirty-two phases of the VCO input reference signal VCO_{OUT<}31:0> to present a drive signal to trigger a toggle flip-flop and generate a frequency output signal Z having a rising edge and a falling edge. A control word FREQ <9:0> (a digital word) determines the time (i.e., the number of phases) that should elapse between two adjacent selections of address by the frequency synthesizer multiplexer device. A frequency synthesis register provides and memorizes the extant selection address of the frequency synthesizer multiplexer device. The drive signal is applied as a clocking signal for the frequency synthesis register. The next subsequent frequency synthesizer multiplexer selection address stored in the frequency synthesis register is the sum of the extant selection address and the control word FREQ <9:0>.

When such a frequency synthesizer device employs a control word having a fractional bit there will be jitter in output signals from the synthesizer device.

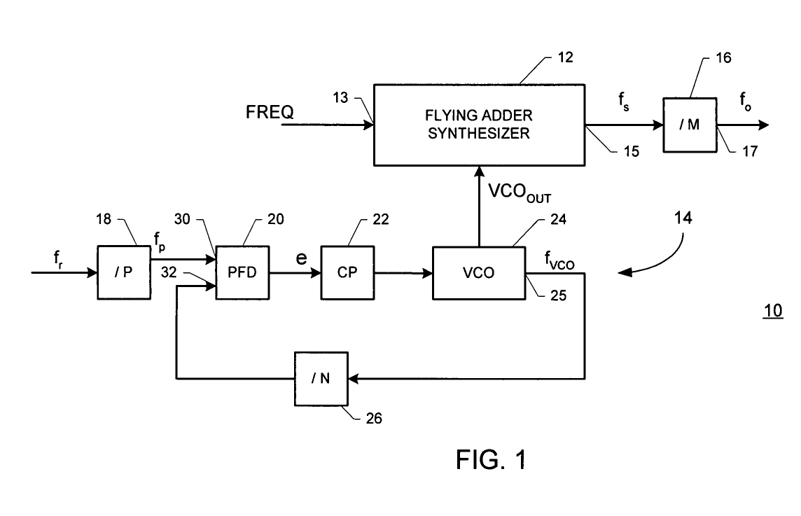

FIG. 1 is a schematic block diagram illustrating the apparatus of the present invention. In FIG. 1, a frequency synthesizing apparatus 10 includes a flying adder frequency synthesizer 12, a frequency reference unit 14 and a Post Divider Fractional Recovery (PDFR) unit 16.

Frequency reference unit 14 includes a scaling unit 18, a frequency and phase detector (PFD) 20, a charge pump 22, a Voltage Controlled Oscillator (VCO) 24 and a divider unit 26. Frequency reference unit 14 is configured substantially as a single-loop analog Phase Locked Loop (PLL) circuit receiving a reference signal having a reference frequency fᵣ at scaling unit 18. Scaling unit 18 may be employed to divide the reference signal to a lower, more manageable frequency by dividing using a scaling factor P. Some configurations of frequency reference unit 14 may omit scaling unit 18. Scaling unit or predividing unit 18 presents a scaled reference signal having a scaled frequency f_{P} to an input locus 30 to PFD 20. PFD 20 senses whether a difference is present between two input signals received at input loci 30, 32 to PFD 20, and presents an error indication e to charge pump 22 when a sufficient signal difference is present. Charge pump 22 converts error indication e to a representative voltage signal for use by VCO 24 in generating a reference signal VCO_{OUT}. VCO 24 also presents signal VCO_{OUT}, having a frequency f_{VCO}, at an output locus 25. Output locus 25 is coupled with divider 26. Divider 26 divides feedback signal VCO_{OUT} by a factor N to present to input locus 32 to PFD 20. When frequency reference unit 14 achieves the lock state, the following relationship is established:

$${f}_{P} = \frac{{f}_{VCO}}{N} \qquad [ 1 ]$$

In the configuration illustrated in FIG. 1, frequency reference unit 14 is configured with a fixed divide ratio N and a fixed divide ratio P. As a result VCO 24 oscillates at a single frequency f_{VCO}. Reference signal VCO_{OUT} has multiple outputs that all have the same frequency, but each has its own unique phase. There are K outputs (phases) from VCO 24. All of the VCO_{OUT} outputs have the same phase delay Δ relative to their respective neighboring phases. The VCO_{OUT} outputs are provided as inputs to flying adder synthesizer 12, preferably using one or more K:1 multiplexers (not shown in FIG. 1). Synthesizer 12 also receives a digital control word FREQ at an input locus 13. Control word FREQ operates as a digital frequency and phase control cooperating with synthesizer 12 to effect presenting a synthesized signal f_{S} at an output locus 15.

By the nature of this “Flying-Adder” architecture, control word FREQ must be in the range as shown in equation [2]. Control word FREQ could be an integer or a real number. If cycle jitter is to be avoided, control word FREQ can only take integer values.

2≦FREQ<2N [2]

A preferred embodiment of the present invention, as illustrated in FIG. 1, is configured as a divider unit: PDFR unit 16. PDFR unit 16 divides synthesized signal f_{S} by an integer M to present an output signal having a frequency f_{O} at an output locus 17.

Frequency synthesizing apparatus 10 may be described as operating according to the following mathematical relationships:

$${f}_{P} = \frac{{f}_{r}}{P} \qquad [ 3 ]$$

where, f_{P}=scaled frequency after predivider unit 18;
   fᵣ=reference frequency presented to predivider unit 18; and
   P=scaling factor P.

$$\begin{matrix}{f}_{VCO} = N \cdot {f}_{P} \\ = N \cdot \frac{{f}_{r}}{P}\end{matrix} \qquad \begin{matrix}[ 4 ] \\ [ 5 ]\end{matrix}$$

Therefore, the period T_{VCO} of signal from VCO 24,

$$\begin{matrix}{T}_{VCO} = \frac{1}{{f}_{VCO}} \\ = \frac{P}{N \cdot {f}_{r}}\end{matrix} \qquad \begin{matrix}[ 6 ] \\ \begin{matrix} \\ [ 7 ]\end{matrix}\end{matrix}$$

Phase delay Δ between neighboring phases of signal VCO_{OUT} may be expressed as:

$$Δ = \frac{{T}_{VCO}}{K} \qquad [ 8 ]$$

Where, K=Number of phases of signal VCO_{OUT}.

Synthesized frequency f_{S} is divided by factor M, so that:

f_{S}=M·f_{O} [9]

Period T_{S} of signal f_{S}:

$$\begin{matrix}{T}_{S} = \frac{1}{{f}_{S}} \\ = \frac{1}{M \cdot {f}_{O}}\end{matrix} \qquad \begin{matrix}[ 10 ] \\ \begin{matrix} \\ [ 11 ]\end{matrix}\end{matrix}$$

Recall that frequency f_{S} is the required output frequency from synthesizer 12. The following relationship is defined by the architecture:

T_{S}=FREQ·Δ [12]

Combining Expression [12] with expressions [11], [7] and [8]:

$$\frac{1}{M \cdot {f}_{O}} = FREQ \cdot \frac{P}{N \cdot {f}_{r} \cdot K} \qquad [ 13 ]$$

Manipulating expression [13] yields:

$$\frac{{f}_{r}}{{f}_{O}} = \frac{FREQ \cdot P \cdot M}{N \cdot K} \qquad [ 14 ]$$

When control word FREQ has fractional bits, signal f_{S} will have inherent jitter because of a periodical carry-in. Post divider factor M may be employed to compensate for fractional bits in control word FREQ when certain relation exists between control word FREQ and post divider factor M. So long as the fractional bits in control word FREQ is the inverse of a factor of post divider factor M, jitter can be removed from signal f_{S}.

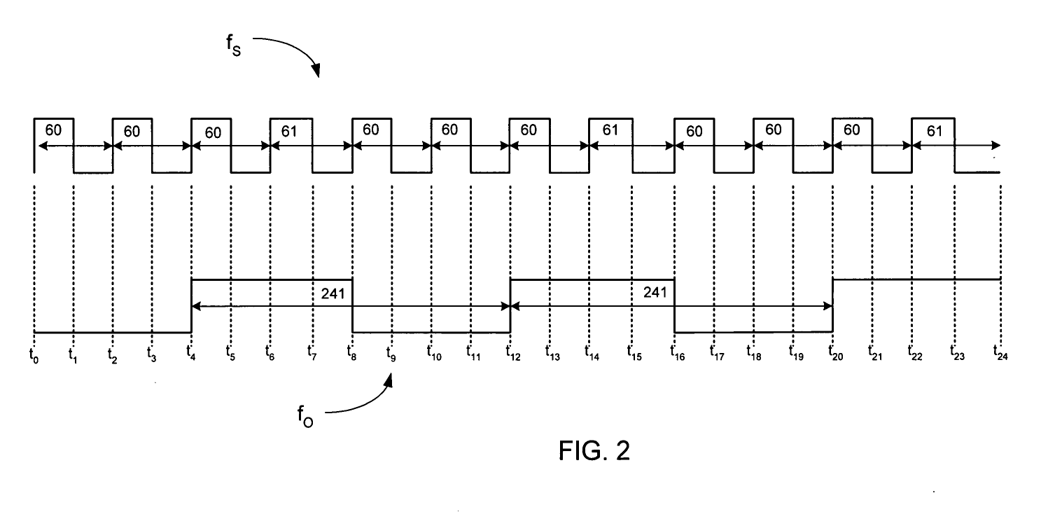

FIG. 2 is a timing diagram illustrating operation of the present invention. In FIG. 2, a first signal representation f_{S} represents synthesized signal f_{S} presented at output locus 15 (FIG. 1). A second signal representation f_{O} represents output signal f_{O} presented at output locus 17 after treatment by PDFR unit 16 (FIG. 1).

Representative synthesized signal f_{S} (FIG. 2) results from a control word FREQ having fractional bits (FREQ=60.25). In the exemplary situation illustrated in FIG. 2, control word FREQ causes representative synthesized signal f_{S} to have an average frequency (60.25·Δ). The fractional bit of control word FREQ is not manifested until the fractional bit (i.e., 0.25) accumulates to a value of 1. As a result, representative synthesized signal f_{S} has a period of 60 during a period occupying time interval t₀-t₂, during a time interval t₂-t₄ and during a time interval t₄-t₆. However, representative synthesized signal f_{S} has a period of 61 during a period occupying time interval t₆-t₈ because the fractional bits of control word FREQ have accumulated to equal 1 during the time interval t₆-t₈. This varied period for representative synthesized signal f_{S} will be manifested as cycle jitter at 1·Δ.

Treating representative synthesized signal f_{S} by employing PDFR unit 16 (FIG. 1) for applying post divider factor M=4 yields representative output signal f_{O} (FIG. 2). Representative output signal f_{O} has a period of 241 with no jitter during a time interval t₄-t₁₂ and during a time interval t₁₂-t₂₀. One skilled in the art of frequency synthesis will recognize that representative output signal f_{O} will continue after time t₂₀. An output signal f_{O} with a period of 241 free of jitter could not be produced using frequency synthesizing apparatus 10 (FIG. 1) without PDFR unit 16.

Recall expression [14]:

$$\frac{{f}_{r}}{{f}_{O}} = \frac{FREQ \cdot P \cdot M}{N \cdot K} \qquad [ 14 ]$$

Without employing PDFR unit 16 (FIG. 1), control word FREQ can only take on integral values as established by expression [2]:

2≦FREQ<2N [2]

When PDFR unit 16 is employed, fractional values for control word FREQ may be employed, so long as the fractional value is the inverse of a factor of post divider factor M. By way of example and not by way of limitation, if post divider factor M=16, then its factors are 1, 2, 4, 8, 16. As a consequence, fractional values of control word FREQ may be 0.5, 0.25, 0.125 and 0.0625.

Employment of the present invention, such as by way of example and not by way of limitation employment of post divider factor M in a PDFR unit 16 (FIG. 1), will not permit synthesis of all frequencies without jitter. However, employment of the present invention will permit synthesis of more frequencies without jitter than can be achieved without employment of the present invention. Said another way, the present invention permits employment of control words having some fractional bits to synthesize an increased number of frequencies without jitter than has been possible with prior art frequency synthesizing devices limited to using control words without fractional bits for synthesizing jitter-free signals.

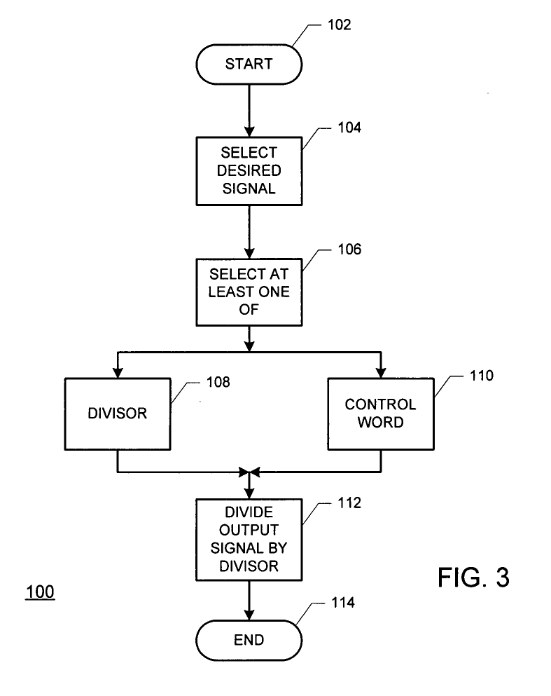

FIG. 3 is a flow chart illustrating the method of the present invention. In FIG. 3, a method 100 for synthesizing a desired signal substantially free of jitter using a frequency synthesizing device employing a control word having a fractional bit begins at a START locus 102. The frequency synthesizing device presents an output signal. Method 100 continues with the step of selecting the desired signal, as indicated by a block 104. Method 100 continues with the step of, in no particular order, selecting at least one of (as indicated by a block 106) the divisor, as indicated by a block 108 and the control word, as indicated by a block 110. The selecting is effected to permit carrying out the following step: dividing the output signal by the divisor to present the desired signal, as indicated by a block 112. Method 100 terminates at an END locus 114.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. A method for reducing jitter in an output signal from a frequency synthesizer using a control word having a fractional bit; the method comprising dividing said output signal by a predetermined divisor to present a modified output signal substantially free of jitter.

2. A method for reducing jitter in an output signal from a frequency synthesizer using a control word having a fractional bit as recited in claim 1 wherein said fractional bit is the inverse of a factor of said divisor.

3. A method for reducing jitter in an output signal from a frequency synthesizer using a control word having a fractional bit as recited in claim 1 wherein said modified output signal is a specified signal, and wherein one of said control word and said divisor is selected to present said specified output signal.

4. A method for reducing jitter in an output signal from a frequency synthesizer using a control word having a fractional bit as recited in claim 2 wherein said modified output signal is a specified signal, and wherein one of said control word and said divisor is selected to present said specified output signal.

5. A method for reducing jitter in an output signal from a frequency synthesizer using a control word having a fractional bit as recited in claim 1 wherein said modified output signal is a specified signal, and wherein said control word and said divisor are selected to cooperate in presenting said specified output signal.

6. A method for reducing jitter in an output signal from a frequency synthesizer using a control word having a fractional bit as recited in claim 2 wherein said modified output signal is a specified signal, and wherein said control word and said divisor are selected to cooperate in presenting said specified output signal.

7. A method for synthesizing a desired signal substantially free of jitter using a frequency synthesizing device employing a control word having a fractional bit; said frequency synthesizing device presenting an output signal; the method comprising:
(a) selecting said desired signal;
(b) in no particular order, selecting at least one of:
(1) said divisor; and
(2) said control word; said selecting being effected to permit carrying out step (c); and
(c) dividing said output signal by said divisor to present said desired signal.

8. A method for synthesizing a desired signal substantially free of jitter using a frequency synthesizing device employing a control word having a fractional bit as recited in claim 7 wherein said fractional bit is the inverse of a factor of said divisor.

9. A method for synthesizing a desired signal substantially free of jitter using a frequency synthesizing device employing a control word having a fractional bit as recited in claim 7 wherein said selecting at least one of said divisor and said control word is effected as a selecting of said divisor.

10. A method for synthesizing a desired signal substantially free of jitter using a frequency synthesizing device employing a control word having a fractional bit as recited in claim 8 wherein said selecting at least one of said divisor and said control word is effected as a selecting of said divisor.

11. An apparatus for synthesizing a desired signal substantially free of jitter; the apparatus comprising:
(a) a frequency synthesizing device; said frequency synthesizing device employing a control word having a fractional bit; said frequency synthesizing device presenting an output signal; and
(b) a dividing unit coupled with said frequency synthesizing device; said dividing unit dividing said output signal by a divisor to present said desired signal.

12. An apparatus for synthesizing a desired signal substantially free of jitter as recited in claim 11 wherein said fractional bit is the inverse of a factor of said divisor.

13. An apparatus for synthesizing a desired signal substantially free of jitter as recited in claim 11 wherein one of said control word and said divisor is selected to present said desired signal.

14. An apparatus for synthesizing a desired signal substantially free of jitter as recited in claim 12 wherein one of said control word and said divisor is selected to present said desired signal.

15. An apparatus for synthesizing a desired signal substantially free of jitter as recited in claim 12 wherein said control word and said divisor are selected to cooperate in presenting said specified output signal.
